(19) United States
(12) Patent Application Publication
(10) Pub. No.: US 2018/0370810 A1
(43) Pub. Date: Dec. 27, 2018

(54) A PROCESS FOR PRODUCTION OF AMMONIA FROM INERT-FREE SYNTHESIS GAS IN MULTIPLE REACTION SYSTEMS

(71) Applicant: HALDOR TOPSØE A/S, Kgs. Lyngby (DK)

(72) Inventors: Annette E. KRØLL JENSEN, Fredensborg (DK); Per Juul DAHL, Vedbæk (DK)

(73) Assignee: HALDOR TOPSØE A/S, Kgs. Lyngby (DK)

(21) Appl. No.: 16/062,259

(22) PCT Filed: Nov. 15, 2016
(86) PCT No.: PCT/EP2016/077690

§ 371 Date: Jun. 14, 2018

(30) Foreign Application Priority Data
Dec. 16, 2015 (DK) PA 2015 00811

(51) Int. Cl. C01C 1/04

(52) U.S. Cl. CPC C01C 1/047

(57) ABSTRACT

In a process for the production of ammonia in at least two reaction systems, in which ammonia is produced from a portion of the synthesis gas in each of the systems with a part-stream being withdrawn, the make-up gas is essentially inert-free, the downstream system is at the same pressure or at a higher pressure than the upstream system and the make-up gas is sent once through a make-up gas (MUG) converter unit, the residual synthesis gas coming from the MUG converter unit is optionally pressurized to a higher pressure before being sent to an inert-free synthesis loop. This way, an economically attractive production of ammonia is feasible with synthesis gases not containing inerts.

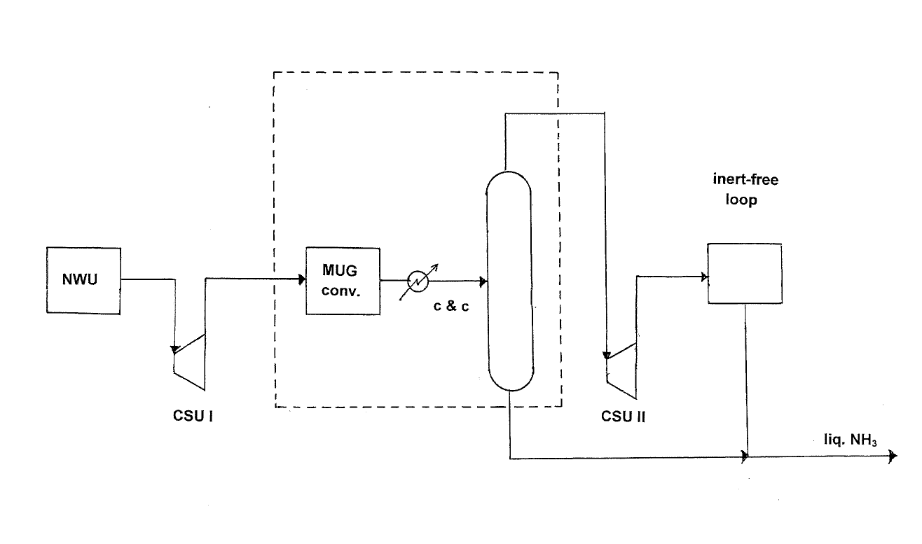

The present invention relates to a process for production of ammonia from inert-free synthesis gas in at least two reaction systems. More specifically, ammonia is produced in a multiple-pressure process from inert-free synthesis gas according to the reaction

N₂+3H₂->2NH₃ (1)

in at least two reaction systems.

Ammonia is produced from synthesis gas by catalytic reaction between hydrogen and nitrogen according to reaction (1) in a high-pressure synthesis loop. Besides hydrogen and nitrogen, the ammonia synthesis gas contains components, which are usually inert to reaction (1), such as methane and noble gases, which impede the conversion rate of reaction (1) and which will hereinafter be referred to as “inert components” or simply “inerts”. Processes of this type are usually operated in such a way that the make-up gas is first compressed in several stages to a high pressure, and then the compressed make-up gas is fed to a loop which en-compasses one or more catalyst-filled reactors to produce ammonia. It is known in the art to feed the high-pressure loop with a make-up synthesis gas, which mainly consists of H₂ and N₂ in a suitable molar ratio (i.e. 3 to 1), obtained by steam reforming of a hydrocarbon feedstock such as natural gas.

In order to avoid an enrichment in the loop of the inert components, which are contained in the withdrawn ammonia and which are only soluble at very low concentrations, a part-stream of the gases circulated in the loop is continuously withdrawn as purge gas. The residual ammonia is removed from this purge gas by scrubbing, the hydrogen and the nitrogen, if any, being removed and recovered by using membrane technology or low-temperature separation. The residual inert components, such as methane, argon, helium and residual nitrogen, if any, are discharged. The recycle gas is added to the make-up gas before it is compressed, and thus re-used. It is detrimental to the energy balance to withdraw large amounts of purge gas from the loop since this would cause a significant drop in pressure for large volumes of gas, which must then undergo secondary compression with much expenditure incurred.

This is the reason why the skilled person has so far been convinced than an enrichment of inerts from an original value of 1-2 vol % in the make-up gas to 10 vol % or even 20 vol % cannot be avoided within the recycle gas, even though there is the inevitable disadvantage associated with these high concentrations of inerts that the partial pressure of the gases participating in the reaction, which alone are crucial for the state of the reaction equilibrium as affin-ity to the reaction, are significantly lower than they would be in a completely inert-free synthesis gas loop. This is the reason why the volume of the catalysts used and the reactors housing them must be significantly larger than would be required without the presence of inert components in the synthesis gas loop.

The enrichment of inerts in the loop compared to the original level of concentration in the make-up gas, which is tolerated despite the disadvantages described above, demon-strates the technical paradox which arises because of the fact that the operating costs, particularly those related to compression, decrease in the presence of smaller amounts of purge gas and thus higher concentrations of inert components, while the capital costs increase due to the larger catalyst volumes required, or the need of alternatively using more expensive catalysts, such as those based on ruthenium. This technical paradox cannot be resolved using cur-rent state-of-the-art technologies, and this is why the specialist in this field is compelled to find some compromise and to establish the optimal cost balance in respect of high operational expenditure and capital cost.

The synthesis taking place in the reactor yields product gas from the synthesis gas. This product gas primarily consists of the unreacted portion of the feed gas, the ammonia formed and the inert components. The ammonia is gaseous at the reactor outlet, but it must be condensed so that it can be separated from the product gas and also be withdrawn as liquid ammonia from the loop. Since the dew point of ammonia depends on its partial pressure and its temperature, it is an advantage for the condensation of the product to pro-vide a higher synthesis pressure and a high ammonia concentration on the one hand, while having a lower temperature on the other hand. A high ammonia concentration can be obtained by using large catalyst volumes at low concentrations of inerts. A high synthesis pressure leads to a cor-respondingly higher cost of energy required to compress the synthesis gas, and a lower cooling temperature demands that an appropriate cooling apparatus is installed in the recycle gas piping.

The above considerations reveal the reasons why a person skilled in the art will normally tend to maintain the working synthesis pressure between 150 and 280 bar. Since the volume of conventional magnetite catalysts will grow dis-proportionately if the synthesis pressure is lowered, and since this also applies to the constructional requirements for the reactors, the processes described in the art use highly active catalysts. Thus, magnetite catalysts doped with cobalt have been used in large amounts. Also ruthenium catalysts have been used, but these are more expensive because of the noble metal content.

The lower the synthesis pressure is, the lower is also the amount of heat which can be dissipated by using water or air cooling, and as a consequence the portion of heat to be removed by refrigeration will increase accordingly. This leads to a further technical paradox if it is considered, as in standard practice, that the refrigeration requires a cooling circuit with a compressor system. While the compression expenditure for the synthesis loop declines as the synthesis pressure decreases, the compression expenditure for the cooling circuit increases since more refrigeration is required to withdraw the ammonia produced in the synthesis loop. The portion of ammonia condensed prior to refrigeration is increased in low-pressure processes in that a very low concentration of inert components is set by means of a high flow rate of the purge gas stream. The problem with the enrichment of inert components occurs as in the high-pressure synthesis process, and a lower concentration of inerts increases the product concentration and conse-quently the dew point. Hence, the person skilled in the art must in this case, too, find a compromise and establish an optimal cost balance in respect of high operational expenditure and investment costs.

In most conventional ammonia plants, natural gas is pro-cessed in primary and secondary reformers to generate hydrogen, and the reformed gas stream is then subjected to a shift conversion for additional hydrogen production after excess heat has been recovered from the reformed gas stream. In a still further step, acid gases are removed, and residual carbon monoxide (CO) and carbon dioxide (CO₂) are converted into methane in a downstream methanator. The resulting raw synthesis gas stream is then passed into the synthesis loop for the production of ammonia, wherein the nitrogen is typically provided from process air being fed into the secondary reformer.

Typically, an ammonia plant will use a stoichiometric amount of process air in the secondary reformer to maintain a hydrogen-to-nitrogen molar ratio of 3 to 1 in the methanator effluent gas (raw synthesis gas), which is normally the make-up gas to the ammonia synthesis loop.

For many years, commercial scale production of ammonia has been carried out in large single reaction systems. The single reaction system is the result of the high costs associated with a loop operated at high pressure and of the high costs for the compression process, which both are subject to high degression with increasing flow rates. Hence, some technical prejudice was held for decades, stating that economically attractive production of ammonia was feasible only in single reaction systems and only with synthesis gases containing inerts.

One of the first attempts to use more than one reaction system is disclosed in DD 225 029 A3, which describes two high-pressure synthesis units arranged one after the other and operated at the same pressure levels. The first synthesis unit is a make-up gas system and the second is a conventional loop system. The synthesis gas used must contain inerts, and during the process the concentration of inerts is rather high, more specifically 13-18 vol % in the recycle gas.

It is known from U.S. Pat. No. 7,070,750 B2 that ammonia can be produced from synthesis gas in a multiple-pressure process, where the synthesis of ammonia takes place in at least two lined-up synthesis systems. According to this US patent, ammonia is produced from a portion of the synthesis gas in each system with a part-stream being withdrawn and the respective downstream synthesis system being operated at a higher pressure than the respective upstream synthesis system. In this connection, “higher pressure” means a differ-ential pressure which exceeds the pressure losses within the synthesis system. Each synthesis system may be separated from the next downstream synthesis system by at least one compression stage.

In the process described in U.S. Pat. No. 7,070,750 B2, all of the at least two synthesis systems operate as make-up gas systems with the exception of the last synthesis system, which is operated as a recycle loop system.

The process disclosed in U.S. Pat. No. 7,070,750 B2 produces ammonia according to the reaction (1) mentioned above from synthesis gas containing the reactants H₂ and N₂ as well as compounds, which are inert to reaction (1), such as methane and noble gases, which impede the conversion rate of reaction (1). In order to avoid an enrichment in the loop of the inert compounds, a part-stream of the gases circulated in the loop is continuously withdrawn as a purge gas. It is recognized in U.S. Pat. No. 7,070,750 B2 that inert compounds consti-tute a problem because their concentration increase from an original value of 1-2 vol % in the make-up gas up to 10 or even 20 vol % within the recycle gas, resulting in the partial pressures of the gases participating in the reaction being significantly lower than they would be in an inert-free synthesis gas loop. This disadvantage is generally compensated for by using larger catalyst volumes and accordingly larger reactors, or alternatively by using more effective (but also more expensive) catalysts such as those based on ruthenium. According to U.S. Pat. No. 7,070,750 B2, the mul-ti-pressure process described therein can lead to satisfac-tory results despite the permanent presence of inert compounds in the synthesis gas.

The present invention is based on the idea that ammonia can be produced from an inert-free synthesis gas according to the above reaction (1) in at least two reaction systems, where the downstream system is at the same pressure or at a higher pressure than the upstream system. The synthesis gas or make-up gas is coming from a nitrogen wash unit (NWU) or other cleaning unit, where all inert compounds have been removed down to ppm level. This means that, for all practi-cal purposes, the ammonia synthesis loop is inert-free and therefore a purge system is not required.

In the present disclosure, the terms “synthesis gas” and “make-up gas” are used interchangeably.

Thus, the present invention relates to a process for the production of ammonia in at least two reaction systems which comprise lined-up synthesis systems including a first system and a last system, in which
ammonia is produced from a portion of the ammonia synthesis gas in each of the at least two systems with a part-stream being withdrawn,
the make-up gas is essentially inert-free,
the downstream system is at the same pressure or at a higher pressure than the upstream system, and
the synthesis gas or make-up gas is sent once through a make-up gas (MUG) converter unit,
   and wherein the residual synthesis gas coming from the MUG converter unit is optimally pressurized to a higher pressure before being sent to an inert-free synthesis loop.

The make-up gas is preferably coming from a nitrogen wash unit (NWU).

The first system in the line of synthesis systems operates as a once-through reactor system. All of the at least two synthesis systems can operate as once-through reactor systems with the exception of the last synthesis system. The last synthesis system operates as a recycle loop system.

In the line of synthesis systems, each synthesis system is separated from the next downstream synthesis system by a compression stage.

Since the loop is inert-free, no purge system whatsoever is required. The make-up gas is very reactive due to the fact that no inerts are present.

The advantage of having a MUG converter unit at a lower pressure level than the main loop is that it will be much easier to control the exothermic reaction (1) and to obtain a reasonable reactor size of the MUG converter.

The invention is explained further with reference to the figure, where a nitrogen wash unit NWU delivers a make-up gas with a content of inert compounds, which is practically zero.

The ammonia synthesis gas may be pressurized after leaving the NWU, which is done in a first compressor stage/unit (CSU I), and then it is sent once through a make-up gas (MUG) converter unit. This MUG converter unit, which is in-dicated as a dotted frame in the figure, consists of the MUG converter itself (MUG cony.) together with cooling and condensing (c & c) means.

The residual synthesis gas coming from the MUG converter unit is pressurized to a higher pressure in a second compressor stage/unit (CSU II) before being sent to an inert-free synthesis loop, in which liquid ammonia is produced.

The invention will be illustrated further by the example which follows.

### EXAMPLE

Table 1 shows the key figures for a comparison of a 3000 MTPD ammonia plant based on an inert free synthesis loop, with a 3000 MTPD ammonia plant based on an inert free make-up gas and the make-up gas converter unit placed at three different pressure levels. It is shown that it is possible to produce at least 20% of the ammonia in the MUG unit.

Considering that the circulation flow can be used as an in-dicator for the synthesis loop equipment size, it is shown that an MUG unit reduces the size of the synthesis loop by at least 15%. This reduction in synthesis loop size repre-sents a possible capex saving, but more importantly it pro-vides a possibility to build a higher capacity ammonia plant, either in form of a new plant or as a capacity increase of an existing plant.

It should be noted that the numbers for production and circulation flow can be further optimized.

TABLE 1
base case: 3000 MTPD ammonia plant
with inert-free synthesis loop

| MUG unit | Synthesis loop | MUG unit NH₃ | Synthesis loop |
|---|---|---|---|
| pressure | pressure | production % of | circulation flow |
| kg/cm² · g | kg/cm² · g | total production | % of base case |
| 30 | 196 | 10 | 97 |
| 84 | 196 | 15 | 90 |
| 192 | 196 | 20 | 85 |

1. A process for the production of ammonia in at least two reaction systems, in which
ammonia is produced from a portion of the ammonia synthesis gas in each of the at least two systems with a part-stream being withdrawn,
the make-up gas is essentially inert-free,
the downstream system is at the same pressure or at a higher pressure than the upstream system, and
the synthesis gas or make-up gas is sent once through a make-up gas (MUG) converter unit,
and wherein the residual synthesis gas coming from the MUG converter unit is optionally pressurized to a higher pressure before being sent to an inert-free synthesis loop.

2. Process according to claim 1, wherein the make-up gas is coming from a nitrogen wash unit (NWU).

3. Process according to claim 1, wherein the first synthesis system operates as a once-through reactor system.

4. Process according to claim 1, wherein all of the at least two synthesis systems operate as once-through reactor systems with the exception of the last synthesis system.

5. Process according to claim 1, wherein the last synthesis system operates as a recycle loop system.

6. Process according to claim 1, wherein each synthesis system is separated from the next downstream synthesis system by one or more compression stages.

7. Process according to claim 1, wherein the downstream system is at the same pressure as the upstream system.
